(19) United States
(12) Patent Application Publication
(10) Pub. No.: US 2002/0133433 A1
(43) Pub. Date: Sep. 19, 2002

(54) Method and system for multi-dynamic product configuration

(75) Inventor: Adam Gregory Hall, Shepherd, MI (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: THE DELFIELD COMPANY

(21) Appl. No.: 10/081,161

(22) Filed: Feb. 22, 2002

Related U.S. Application Data
(60) Provisional application No. 60/271,043, filed on Feb. 23, 2001.

(51) Int. Cl. G06F 17/60

(52) U.S. Cl. 705/27; 705/15

(57) ABSTRACT

A method and system that configures a product system from a plurality of product units selected by a user in an interactive session. The user first selects a profile of the product system layout. Then the user is presented with a plurality of product units from which to choose. As a product unit is selected, a plurality of attributes is presented for selection by the user. Also, each selected product unit is displayed in a configurator area in an order within the selected profile. The user can change the order at any time during the session without requiring any manually entered changes to the selected product units. In addition, changes can be made at any time to the attributes of a previously selected product unit without any need for making manually entered changes to any of the other previously selected units.

This Application claims the benefit of U.S. Provisional Application No. 60/271,043, filed on Feb. 23, 2001.

### FIELD OF THE INVENTION

This invention relates to a method and a system that allows a user to configure a product system with a plurality of individual product units with a minimal knowledge of the product unit designs or configuration rules.

### BACKGROUND OF THE INVENTION

When a buyer decides to procure a product system, a consultant or dealer is consulted. For example, in the food industry, a restaurant may need a product system for a new menu or food offering. The product system might include one or more product units, such as a hot food table, a display case, a utility stand, a work table and the like. Notes of the consultation are taken and sent to personnel of a product system manufacturer. The manufacturing personnel translate the notes into a configuration of product units for the new product system. The product system configuration is returned to the dealer/consultant and buyer. Due to various factors, such as dimensions, desired arrangement order of the product units, customer traffic, number of employees who will use the product system, code standards and the like, the product system configuration may require several additional changes by the buyer and manufacturer before it becomes finalized.

Known configurators have been used to configure a product system. However, these configurators have not been easy to use and, therefore, have required extensive user training to give the user a considerable knowledge of the product units so as to be able to use the configurators. Also, it is difficult with the known configurators to make changes in the attributes of any one product unit without requiring changes to other product units in the product system configuration. Also, there is no easy way to change the flow of the process of the configuration.

There is a need for a user friendly method and configuration system for product units that can be easily used by users with minimal training.

There is also a need for a method and configuration system that permits changes of various types to be made rapidly during the configuration process.

### SUMMARY OF THE INVENTION

The method and system of the invention configures a food service product system based on selections of food service products made by a user during an interactive session. The method of the present invention displays an image of at least two of the food service products within a profile of the system. When an attribute of the profile or of one of the food service products is altered, the displayed image is then altered in response thereto.

According to one aspect of the method, the attribute may be a positional order of food service product within the profile, a dimension of a food service product, a dimension of the profile or any combination thereof.

According to another aspect of the method of the present invention, the profile is identified from a plurality of profiles. According to another aspect of the method, the food service products are selected from a plurality of food service products. The food service products may include an ice cream cabinet, a hot food table, a food display case, a utility stand, an equipment stand, a refrigerated work table, a fry dump station, cashier stand, utensil and tray dispenser, glass or cup rack/dispenser, tray storage unit, bread warmer, soft drink syrup storage, waste unit and a pre-wire electrical unit. According to another aspect of the method of the invention, the attribute is designated from a plurality of attributes, such as gas heat, electric heat, an electrical connection, a fill faucet, a drain, shelving, a door lock, opening, and an appearance of a door, a panel an others.

According to another embodiment of the method of the present invention, at least two of the food service products are displayed in a positional order within a profile of the system. The positional order is altered in response to an instruction of a user. According to one aspect of this embodiment of the method, the profile is identified from a plurality of profiles. According to another aspect of this embodiment of the method, an attribute of one of the food service products is altered. According to another aspect of this embodiment of the method, the display of the food service products within the profile is changed in response to the altering of the attribute.

According to still another embodiment of the method of the present invention, a plurality of profiles is presented to a user. A profile selected by the user is registered. A plurality of food service products is presented to the user. Any of these food service products that are selected by the user are registered. A plurality of attributes is presented to the user for each of the selected food service products. Any of these attributes selected by the user are registered. The selected food service products are displayed in a configuration order within the profile. Any change to the configuration order made by the user is registered and displayed with the food service products in the changed configuration order within the profile.

According to yet another embodiment of the method of the present invention, a plurality of configuration profiles is presented to the user for selection. A configuration profile selected by the user is registered. A plurality of product units is presented to the user. As the user selects a product unit, a plurality of attributes therefor is presented to the user for selection. The selected product units and attributes are registered. The selected product units are displayed in a configuration order within the selected profile. The user can change the configuration order at any time during the session without redefining attributes of any of the product units. Any changes in the configuration order are displayed within the selected profile. Another aspect of the invention is that the user can make changes to already selected attributes of an already selected product unit at any time during the session without requiring any user entered changes to other already selected product units.

The system of the present invention includes a processor and a memory and the means for performing the above noted three embodiments of the method of the present invention.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a block diagram of a system in which the configuration system of the present invention can be used;

FIG. 2 is a block diagram of the computer of the system of FIG. 1;

FIGS. 3-13 depict dialog boxes of the configuration program of the computer of FIG. 2;

FIGS. 14 and 15 depict arrangement order changes to the product configuration of the dialog box of FIG. 13; and

FIG. 16 is a flow diagram of the configuration program of the configurator computer of FIG. 2.

### DESCRIPTION OF THE PREFERRED EMBODIMENT

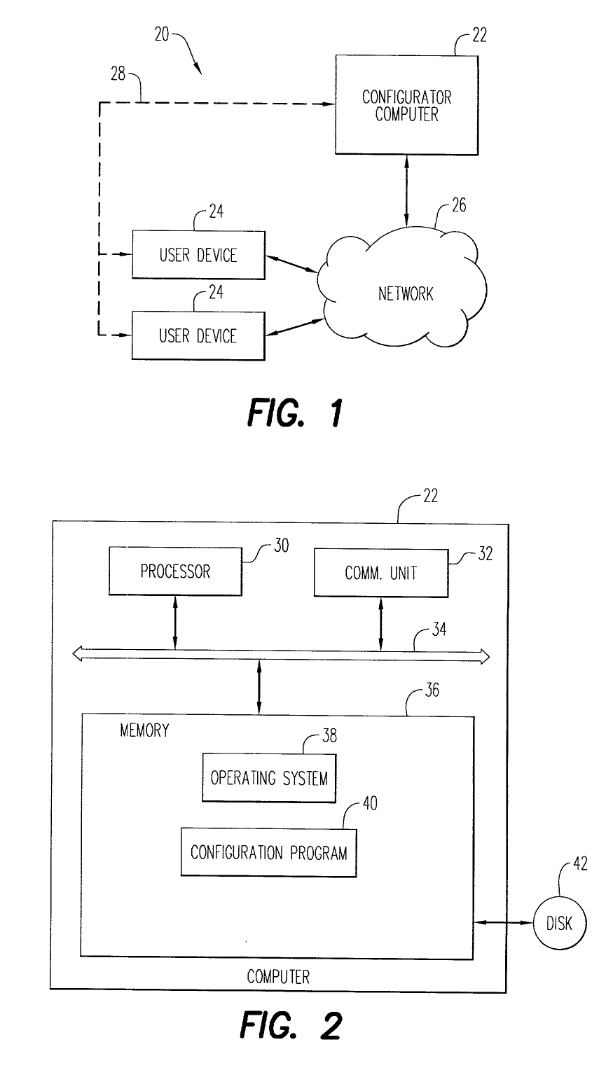

Referring to FIG. 1, a system 20 includes a configurator computer 22 that communicates with one or more user devices 24 via a network 26. User devices 24 may be any suitable device upon which a browser may run, such as a personal computer, a telephone, a television set, a hand held computing device and the like. It will be appreciated by those skilled in the art that the number of user devices is limited only by the capacity of network 26. Network 26 may be an Internet, a World Wide Web (Web), an Intranet, a wired or wireless telephone network, and the like, or any combination thereof. Alternatively, a user device 24 may communicate with configurator computer 22 via an off-line connection shown generally by dashed line 28.

Configurator computer 22 may be any suitable computer, presently known or developed in the future, that is capable of communicating with user devices 24 in a protocol that is compatible with the browser capability of user devices 24 and that is capable of running applications that supply web page data and interact with web page actions taken by user device 24. Configurator computer 22 may be a single computer with a memory system for the storage of data or may comprise a plurality of computers that are interconnected directly, via network 26 or other network (not shown). Configurator computer 22 may be a single computer that communicates directly to network 26 or may be an application server computer that communicates to network 26 via a web server computer (not shown).

Referring to FIG. 2, configurator computer 22 includes a processor 30, a communications unit 32 and a memory 36 that are interconnected via a bus 34. Memory 36 includes an operating system 38 and a configuration program 40 of the present invention. Other programs, such as utilities and other applications, may also be stored in memory 36. All of these programs may be loaded into memory 36 from a storage medium, such as a disk 42.

Processor 30 is operable under the control of operating system 38 to execute configuration program 40 to present one or more screens, web pages and/or dialog boxes to user device 24 for an interactive session and to receive and interact with responses from user device 24. The web pages, if frequently served, may reside in a cache (not shown) of memory 36.

The operator or user of user device 24 may be a buyer, dealer, a manufacturer or other user who wants to configure a product system with one or more product units. An illustrative product unit selection and configuration will be presented for a description of configuration program 40 for a typical session with user device 24.

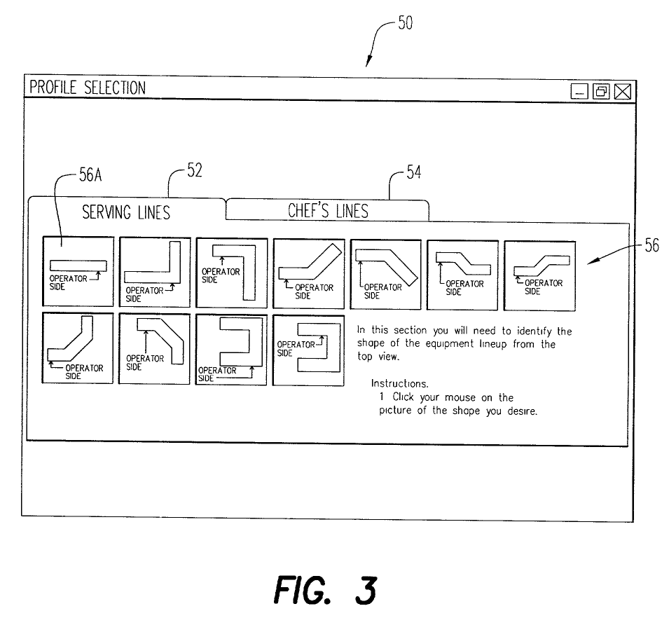

Referring to FIG. 3, a screen (e.g., a display screen) 50 is presented to user device 24 for the user to select a profile of the configuration product system. Screen 50 includes a serving line tab 52 and chef's line tab 54. Serving line tab 52 and chef's line tab 54 each contain a plurality of profiles. By way of example, serving line tab 52 is shown as selected, for example by a mouse click. Serving line tab 52 includes a plurality of serving line profiles 56. For the purpose of example in the following description, it is assumed that the user selects a straight line profile 56A, by positioning a cursor thereon and clicking with a mouse.

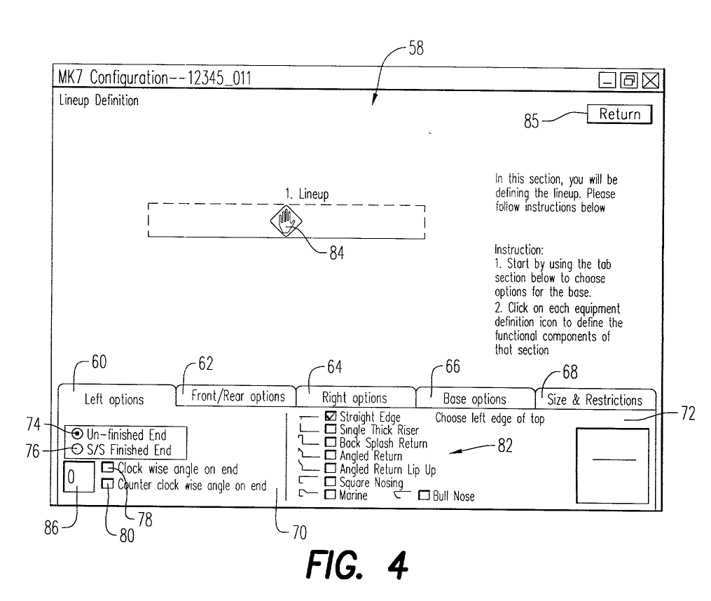

Referring to FIG. 4, a dialog box 58 will then be presented to user device 24. Dialog box 58 begins a series of dialog box presentations that permit the user to define a lineup or order of desired product units for profile 56A. Dialog box 58 includes a number of tabs for defining various features that apply globally to the product units of the product system being configured. To this end, dialog box 58 includes a left options tab 60, a front/rear tab 62, a right options tab 64, a base options tab 66 and a size and restrictions tab 68. By way of example, left options tab 60 is shown as selected in FIG. 4.

Left options tab 60 includes an end options area 70 and a top left edge area 72. End options area 70 includes a pair of boxes 74 and 76 for selection of an unfinished end or a finished end and an additional pair of boxes 78 and 80 for selection of a clockwise or a counterclockwise angle on the left end with the specification of the angle in degrees in a box 86. Top left edge options area 72 includes a plurality of edge definitions 82, each with an associated shape symbol for ease of selection. When left options tab 60 is completed, the user proceeds to complete front/rear options tab 62, right options tab 64, base options tab 66 and size and restrictions tab 68. For the illustrative example, the user, when completing size and restrictions tab 68, specifies a maximum length of 144 inches for an integral assembly of product units. Then the user chooses a lineup icon 84 to register the specified global data and to move on to the next dialog box.

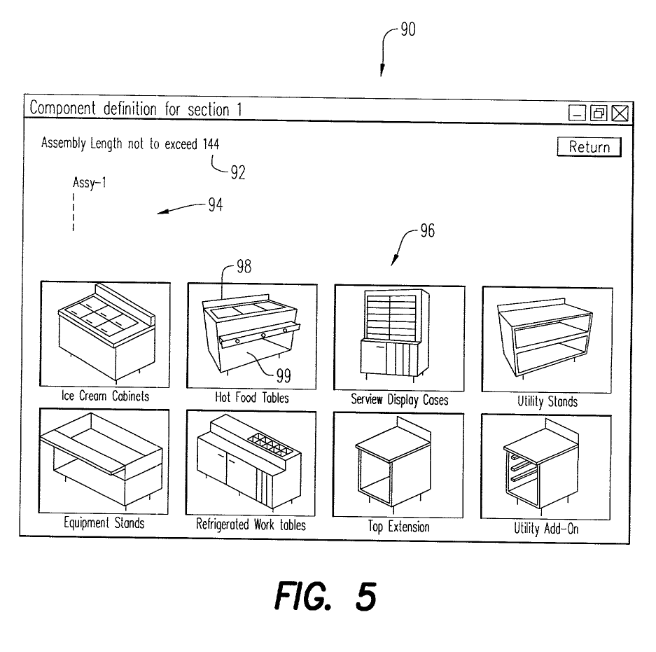

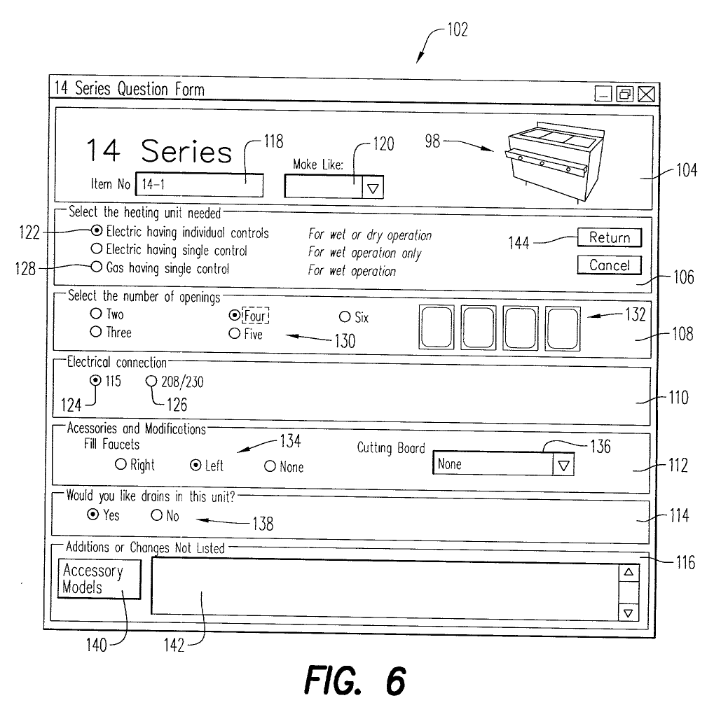

Referring to FIG. 5, a dialog box 90 is next presented to user device 24. Dialog box 90 includes a notation area 92, a configuration area 94 and a product unit area 96. Notation area 92 includes a notice that an assembly length of product units in a single assembly shall not exceed 144 inches. Configuration area 94 will be used during the interactive session to display product units as the user selects during the interactive session. Product units area 96 includes pictures or other images of a plurality of product units that are available to be configured into a product system. For the example of this description, the user selects a hot table product unit 98 by clicking on a pictured icon 99 thereof.

Referring to FIG. 6, a dialog box 102 is presented to user device 24 after pictured icon 99 is chosen for a selection of various attributes of hot table product unit 98. Dialog box 102 includes an item area 104, a heating unit area 106, an openings area 108, an electrical area 110, an accessories area 112, a drains area 114 and an additions area 116. Item area 104 includes a display of hot table product unit 98, an item No. box 118 and a make like box 120. Item No. box 118 is usable by the user for entry of a user defined identity for the product unit. If a specific model number is entered in make like box 120, configuration program 40 automatically enters the information for areas 106, 108, 110, 112 and 114.

If no entry is made in make like box 120, the user must enter the information required for areas 106, 108, 110, 112 and 114. For example, if an electrical box 122 is selected in heating unit area 106, one of the electrical connection boxes 124 or 126 must be selected in electrical area 110. On the other hand, if a gas box 128 is selected in heating units area 106, configuration program 40 will replace electrical area box 110 with a gas area (not shown) for selection of natural gas or propane. Openings area 108 includes boxes 130 for selection of the desired number of openings. When a number, such as the selected number 4, has been entered, configuration program 40 displays an icon 132 having that number of openings.

Accessories area 112 includes faucet boxes 134 and a cutting board box 136. Drain area box 114 includes drain boxes. Additions area 116 includes an accessory models button 140 and a data box 142. Operation of accessory models button allows selection of features or other options. These features are selected from a list (not shown) presented in data box 142 or typed in box 142. When information has been entered in areas 104, 106, 108, 110, 112, and/or area 116, operation of a return button 144 causes a return to dialog box 90.

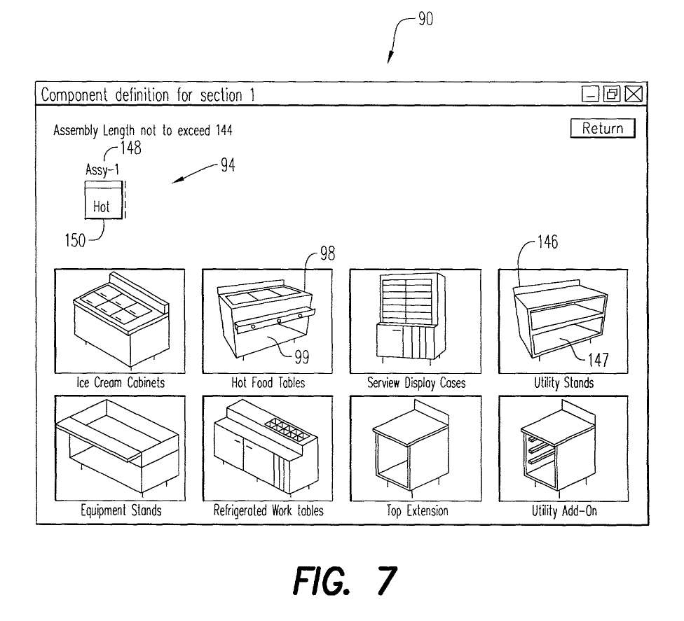

Referring to FIG. 7, dialog box 90 is shown with an update to configuration area 94 that includes a placeholder 150 for hot food table product unit 98. Placeholder 150 is labeled with the word, hot, and defines the location of hot food table product unit 98 in the arrangement order of the product system. A symbol 148, noted as Assy-1, identifies to what units hot food table unit 98 will be assembled as the session continues. To continue, the user selects a utility stand 146 as the next product unit by clicking on a pictured icon 147 thereof.

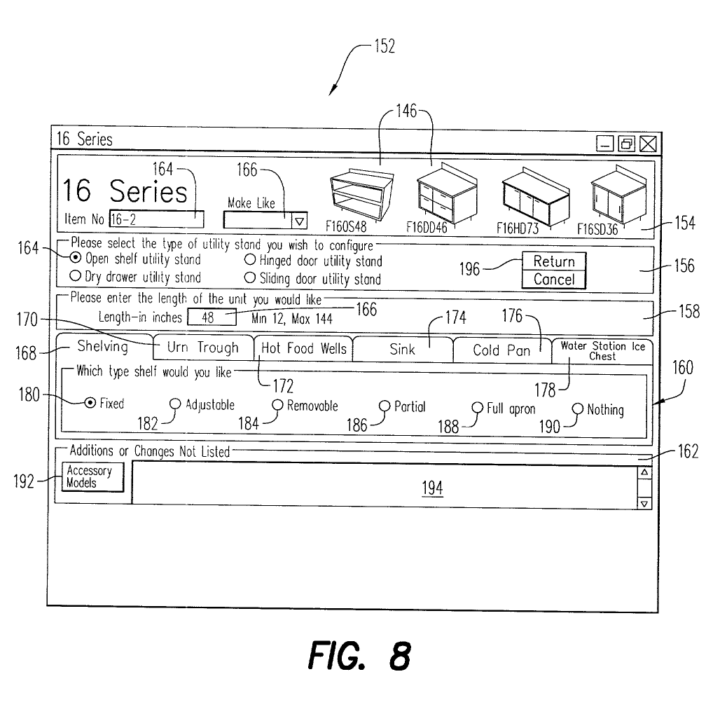

Referring to FIG. 8, a dialog box 152 is presented to user device 24 after icon 147 is chosen for a selection of various attributes of utility stand product unit 146. Dialog box 152 includes an item area 154, a utility type area 156, a unit length area 158, a unit part area 160 and an additions area 162. Item area 104 includes a display of various models for utility stand unit 146, an item No. box 164 and a make like box 166. The functions of item No. box 164 and make like box correspond to the functions of item No. box 118 and make like box 120 of FIG. 6.

If no entry is made in make like box 166, the user must enter the information required for areas 156, 158 and 160. Utility types area 156 includes four different types of utility stands including an open shelf utility stand, which is shown selected at a box 164. Unit length area 158 includes a length box 166 for entry of a length for utility stand 146, which for the illustrative example is 48 inches.

Unit part area 160 includes a number of tabs for defining various parts of utility stand 146. To this end, unit part area 160 includes a shelving tab 168, an urn trough tab 170, a hot food wells tab 172, a sink tab 174, a cold pan tab 176 and a water station ice chest tab 178. By way of example, shelving tab 168 is shown as selected in FIG. 8.

Shelving tab 168 includes a fixed box 180, an adjustable box 182, a removable box 184, a partial box 186, a full apron box 188 and a nothing box 190. Fixed shelving box 180 is selected for the illustrative example. When shelving tab 168 is completed, the user proceeds to complete the remainder of tabs 170, 172, 174, 176 and 178.

Additions area 162 includes an accessory models button 192 and a data box 194. Operation of accessory models button 192 allows selection of features or other options. These features are selected from a list (not shown) presented in data box 194 or typed in box 194. When information has been entered in areas 154, 156, 158, 160 and/or 162, a return button 196 causes a return to dialog box 90.

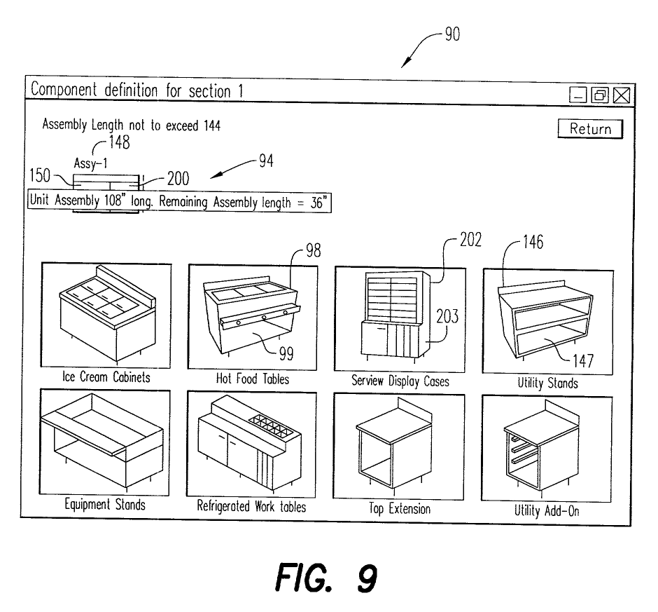

Referring to FIG. 9, dialog box 90 is again presented with an update to configuration area 94 that includes another placeholder 200 positioned adjacent to placeholder 150 for utility stand product unit 146. Symbol 148 now has an extension over both placeholders 150 and 200 to signify that they are part of Assy-1. To continue, the user selects a refrigerated display unit 202 as the next product unit by clicking on a pictured icon 203 thereof.

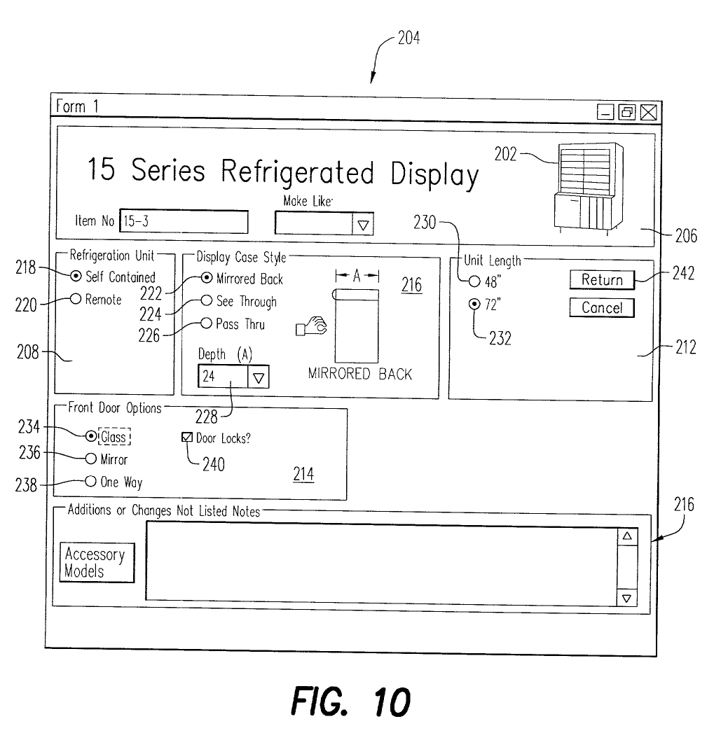

Referring to FIG. 10, a dialog box 204 is presented to user device 24 after icon 203 is chosen for a selection of various attributes of refrigerated display unit 202. Dialog box 204 includes an item area 206, a refrigeration unit area 208, a display case area 210, a unit length area 212, a front door area 214 and an additions area 216. Item area 204 is substantially identical to item areas 104 and 154, except that item area 204 is for refrigerated display unit 202.

If no entry is made in item area 206, the user must enter the information required for areas 208, 210, 212 and 214. Refrigeration unit area 208 includes a self contained box 218 and a remote box 220. Self contained box 218 is shown as selected. Display case area 210 includes a mirrored back box 222, a see through box 224, a pass through box 226 and a depth box 228. For the illustrative example, mirrored box 222 is selected and “24” is entered in depth box 228. Unit length area 212 includes a length box 230 for 48 inches and a length box 232 for 72 inches, of which the latter is selected for the illustrative example.

Front door area 214 includes a glass box 234, a mirror box 236, a one way box 238 and a door locks box 240. Glass box 234 and door locks box 240 are shown as selected. Additions area 216 functions like additions areas 116 and 162 to add additional features to refrigerated display case 202. When information has been entered in areas 206, 208, 210, 212, 214 and/or 216, operation of a return button 242 causes a return to dialog box 90.

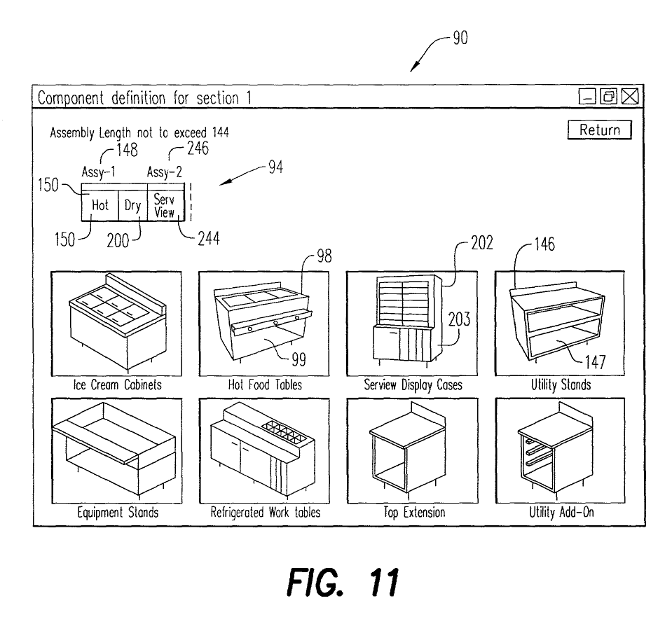

Referring to FIG. 11, dialog box 90 is again presented with an update to configuration area 94 that includes another placeholder 244 for refrigerated display case unit 202 that is positioned adjacent to placeholder 200. A symbol 246, which is labeled as Assy-2, is positioned above placeholder 244 and is separate from symbol 148. This signifies that refrigerated display case unit 202 is part of an assembly Assy-2 that is separate from Assy-1. Symbol 148 now has an extension over both placeholders 150 and 200 to signify that they are part of Assy-1.

An aspect of the present invention is the ability to change attributes of a product unit that have already been specified without requiring manual entries to adjust other product units in the configuration. For example, the user can easily change the length of utility stand 146 by clicking on icon 147.

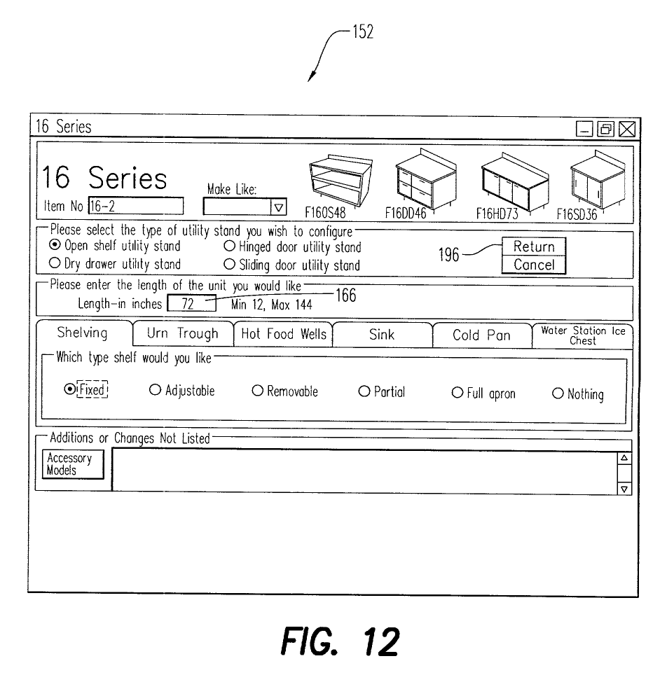

Referring to FIG. 12, dialog box 152 for utility stand 146 is again presented to user device 24. The user changes the entry in box 166 from 48 to 72 inches (compare to FIG. 8). Operation of return button 196 causes dialog box 90 to again be presented to user device 24.

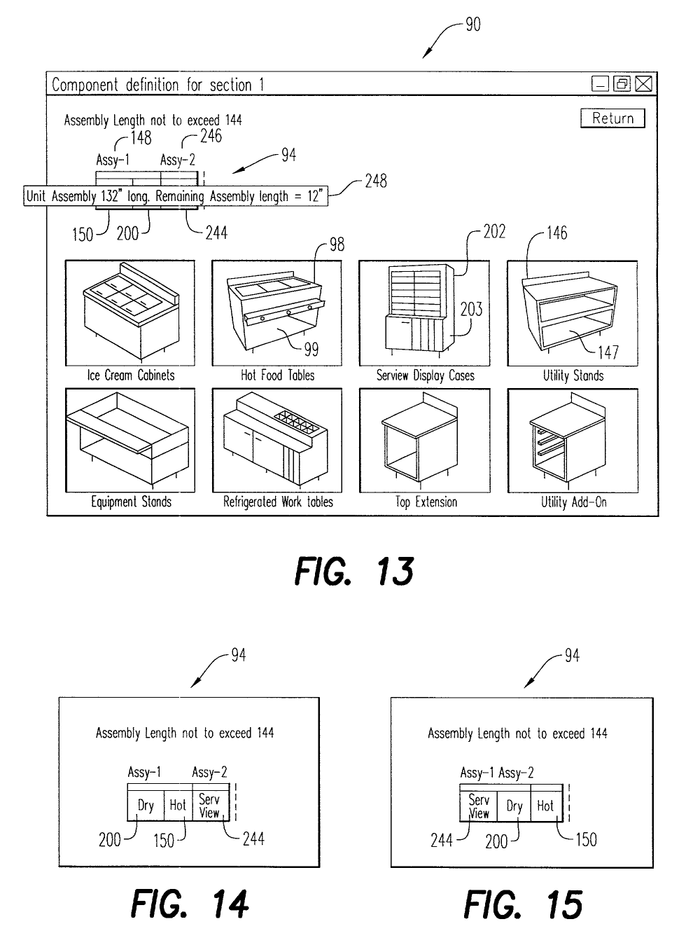

Referring to FIG. 13, it can be seen that placeholder 200 for utility stand 146 is longer and a message 248 is displayed. Message 248 indicates that assembly Assy-1 is now 132 inches long and that there are 12 inches left for the maximum 144 inches length that was previously specified.

Referring to FIGS. 13-15, another aspect of the invention is that the arrangement order or lineup of the product units in configuration area 94 can easily be changed by click and drag operations with a mouse. For example, placeholder 200 (utility stand 202) can be clicked and dragged to the left of placeholder 150 (hot food table 98) for an arrangement order shown in FIG. 14. Another change can be effected by clicking and dragging placeholder 244 to the left of placeholder 200 as shown in FIG. 15. This causes Assy-1 to include placeholder 244 (refrigerated display case 202) and Assy-2 to include placeholder 200 (utility stand 146) and placeholder 150 (hot food table 98). When the user is satisfied with the arrangement order, operation of return button 100 causes configuration program 40 to register the new order. The capability to easily change the order of the product units has some important advantages. For instance, the user can configure the product units in any order during the session and at any time rearrange their order. This allows the configuration procedure to start without delay due to indecision of product unit order. Also, by changing order the flow of the configured product system is changed.

When the user is satisfied with the lineup of the selected product units and the attributes selected for each., clicking on a return button 100 returns to dialog box 58 of FIG. 4. At this point the user can change any of the global options or can end the session by clicking on a return button 85.

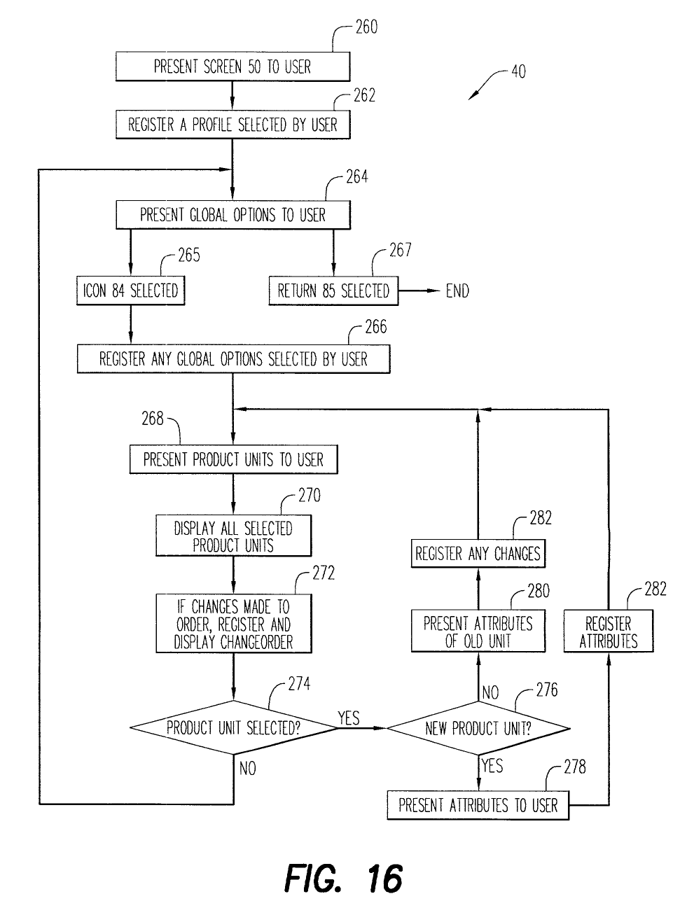

Referring to FIG. 16, configuration program 40 begins at step 260 by presenting screen 50 to the user for selection of a profile. Step 262 registers the profile selected by the user. Step 264 then presents dialog box 58 with global options for selection by the user. If return button 85 is chosen, step 267 ends configuration program 40. If icon 84 is selected, step 265 responds by passing control to step 266. Step 266 then registers any selected global options. Step 268 then presents a plurality of product units in dialog box 90. Step 270 displays all selected product units in configuration area 94. Step 272 records any changes made to the configuration order by the user and displays the changed configuration order.

Step 274 determines if a product unit has been selected. If no, the user has clicked on return button 100 and step 264 is repeated. If yes, step 276 determines if the selected product is a new selection. If yes, step 278 presents a plurality of attributes for the newly selected product unit. Step 282 then registers the selected attributes and step 268 is repeated. If step 276 determines that the selected product unit is one that had previously been selected (old unit), step 280 presents the attributes for the old product unit. Step 282 then registers any changes made by the user to the attributes of the old unit. Step 268 is then repeated.

The present invention having been thus described with particular reference to the preferred forms thereof, it will be obvious that various changes and modifications may be made therein without departing from the spirit and scope of the present invention as defined in the appended claims.

What is claimed is:

1. A method for configuring a system of food service products comprising:
(a) displaying an image of at least two food service products within a profile of said system;
(b) altering an attribute of said profile or of at least one of said at least two food service products; and
(c) altering said image in response to step (b).

2. The method of claim 1, wherein said attribute is selected from the group consisting of: positional order of food service product within said profile, dimension of food service product, dimension of profile and any combination thereof.

3. The method of claim 1, further comprising the step of identifying said profile from a plurality of profiles.

4. The method of claim 3, further comprising the step of selecting said at least two food service products from a plurality of food service products.

5. The method of claim 1, wherein said food service products are selected from the group consisting of: an ice cream cabinet, a hot food table, a food display case, a utility stand, an equipment stand, a refrigerated work table, a fry dump station, cashier stand, utensil and tray dispenser, glass or cup rack/dispenser, tray storage unit, bread warmer, soft drink syrup storage, waste unit and a pre-wire electrical unit.

6. The method of claim 1, wherein said attribute is one of a plurality of attributes, and further comprising designating an attribute of said plurality of attributes for at least one of said at least two food service products, and wherein said plurality of attributes includes gas heat, electric heat, electrical connection, fill faucet, drain, shelving, door lock, opening, and appearance of door or panel.

7. A method for configuring a system of food service products comprising:
(a) displaying at least two of said food service products in a positional order within a profile of said system; and
(b) altering said positional order in response to an instruction of a user.

8. The method of claim 7, further comprising the step of identifying said profile from a plurality of profiles.

9. The method of claim 7, further comprising the step of altering an attribute of at least one of said at least two food service products.

10. The method claim 9, wherein step (a) changes the display of said food service products within said profile in response to the step of altering an attribute.

11. The method of claim 7, wherein step (a) changes the display of said food service products within said profile in response to step (b).

12. A method for configuring a system of food service products comprising:
(a) presenting a plurality of profiles to a user and registering one of said plurality of profiles selected by said user;
(c) presenting to said user a plurality of food service products and registering one or more of said plurality of food service products selected by said user;

13. The method of claim 12,
(c) presenting to said user for each of said selected one or more food service products a plurality of attributes and registering any of said attributes selected by said user;
(d) displaying said one or more selected food service products in a configuration order within said profile; and
(e) registering any change to said configuration order made by said user and displaying said food service products in said changed configuration order within said profile.

14. The method of claim 13, wherein said plurality of attributes are selected from the group consisting of: gas heat, electric heat, electrical connection, fill faucet, drain, shelving, door lock, opening, and appearance of door or panel.

15. The method of claim 13, wherein said food service products are selected from the group consisting of: ice cream cabinet, hot food table, food display case, utility stand, equipment stand and refrigerated work table.

16. A system having a processor and a memory that configures a plurality of food service products into a system configuration, said system comprising:
means for displaying an image of at least two of said plurality of food service products within a profile of said system configuration;
means for altering an attribute of said profile or of at least one of said at least two food service products; and
means for altering said image in response to said attribute being altered.

17. A system having a processor and a memory that configures a plurality of food service products into a system configuration, said system comprising:
means for displaying at least two of said food service products in a positional order within a profile of said system; and
means for altering said positional order in response to an instruction of a user.

18. A system having a processor and a memory that configures a plurality of food service products into a system configuration, said system comprising:
means for presenting a plurality of profiles to a user and registering one of said plurality of profiles selected by said user;
means for presenting to said user a plurality of food service products and registering one or more of said plurality of food service products selected by said user;
means for presenting to said user for each of said selected one or more food service products a plurality of attributes and registering any of said attributes selected by said user;
means for displaying said one or more selected food service products in a configuration order within said profile; and
means for registering any change to said configuration order made by said user and displaying said food service products in said changed configuration order within said profile.
